(19) United States
(12) Patent Application Publication
(10) Pub. No.: US 2006/0085241 A1
(43) Pub. Date: Apr. 20, 2006

(54) Decentralized warehouse management

(76) Inventors: Hans Chelniak, Hockenheim (DE); Joachim Epp, Zuzenhausen (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/504,020

(22) PCT Filed: Feb. 6, 2003
(86) PCT No.: PCT/IB03/00918

§ 371 Date: Apr. 21, 2005

Related U.S. Application Data
(63) Continuation-in-part of application No. 10/137,739, filed on Apr. 30, 2002.
(60) Provisional application No. 60/355,376, filed on Feb. 6, 2002.

(51) Int. Cl. G06F 9/46

(52) U.S. Cl. 705/8

(57) ABSTRACT

Methods and apparatus, including computer program products and systems, implementing and using techniques for managing data related to contents and operations of a warehouse. A request is received from one enterprise resource planning system from among two or more enterprise resource planning systems that are operable to exchange information with the decentralized warehouse management system. The request represents one or more operations to be performed on the contents of the warehouse. The enterprise resource planning system is identified from among two or more enterprise resource planning systems that are operable to exchange information with the decentralized warehouse management system. A response to the request is sent to the enterprise resource planning system from which the request was received.

### BACKGROUND

This invention relates to warehouse management in a supply chain network.

A supply chain network is a network of facilities and distribution options that performs the functions of procuring materials, transforming the materials into semi-finished and finished products, and distributing the finished products to customers. Supply Chain Management (SCM) is a business policy that aims to improve all activities along the supply chain. SCM results in improved integration and visibility within a company, as well as flexibility across supply and demand environments.

Several types of computer software exist that perform the various functions that are needed in a supply chain. One example of a computer software manufacturer for SCM is SAP AG (SAP) of Walldorf, Germany. SAP supplies a solution, “mySAP Supply Chain Management (mySAP SCM),” that is built on an e-business platform and enables end-to-end integration of supply chain planning, execution, networking and coordination. These four groups of functionality form the four key functional areas for the mySAP SCM solution (see www.sap.com for further information).

Companies or businesses that are part of a supply chain typically each have their own Enterprise Resource Planning (ERP) systems. ERP systems are typically supported by SCM solutions such as the mySAP SCM solution. The role of an ERP system is to integrate all departments and functions across a company onto a single computer system that can serve all the different departments' particular needs. An ERP system allows various departments in a company to more easily share information and communicate with each other, as well as with various partners outside the company, such as Logistic Service Providers (LSPs) who handle tasks such as warehouse management, transportation, and so on, for one or more companies.

A LSP typically has one or more systems and associated computer software that supports the functions the LSP has to perform. Examples of such systems include Warehouse Management Systems (WMSs), Transportation Managements Systems, and so on. An ERP can communicate with a dedicated WMS through a WMS module in the ERP.

In existing SAP decentral WMS systems, there is typically a one-to-one correspondence between ERP systems and WMSs. A single LSP might therefore have to install multiple WMSs in order to be able to communicate with several companies' ERP systems. If the LSP provides services for a large number of companies, the LSP may find that installation of multiple WMSs is expensive and that maintenance of multiple WMSs is difficult.

### SUMMARY

In general, in one aspect, this invention provides methods and apparatus, including computer program products and systems, implementing and using techniques for managing data related to contents and operations of a warehouse. A request is received from one enterprise resource planning system from among two or more enterprise resource planning systems that are operable to exchange information with the decentralized warehouse management system. The request represents one or more operations to be performed on the contents of the warehouse. The enterprise resource planning system is identified from among two or more enterprise resource planning systems that are operable to exchange information with the decentralized warehouse management system. A response to the request is sent to the enterprise resource planning system from which the request was received.

Implementations of the invention can include one or more of the following features. The enterprise resource planning systems can be identified including receiving a unique identifier from the enterprise resource planning system from which the request was received. The unique identifier can be used and it can be determined to which enterprise resource planning system the response should be sent. The unique identifier can be a logical system identifier. The unique identifier can be received as part of the request. The decentralized warehouse management system can receive requests from and send responses to an enterprise resource planning systems over a Business Application Programming Interface. The decentralized warehouse management system can manage data related to one or more of: goods movement operations, controlling operations, and inventory operations of the warehouse. The request can be a delivery document. The response can be an updated delivery document. An enterprise resource planning system can be identified using one or more of: an enterprise resource planning system identifier, a method included in the received request, a warehouse identification number, and a logical system identifier.

In general, in one aspect, this invention provides methods and apparatus, including computer program products and systems, implementing and using techniques for managing warehouse operations. A system has two or more enterprise resource planning systems and a decentralized warehouse management system for managing data related to contents and operations of a warehouse. The enterprise resource planning systems can send a delivery document to the decentralized warehouse management system over a business application programming interface. The delivery document includes a unique identifier for the enterprise resource planning system that sends the delivery document. The decentralized warehouse management system can receive the delivery document with the unique identifier, carry out instructions included in the delivery document, and send an updated version of the delivery document to the enterprise resource planning system from which the delivery document was received, based on the unique identifier included in the delivery document.

The invention can be implemented to realize one or more of the following advantages. A LSP only has to maintain a single WMS that can be used to communicate with multiple companies. This leads to great cost savings for the LSP as well as timesavings for maintenance, installation, and so on. The LSP can also get a better overview of the entire warehouse operations, since all the data and requests from the companies is contained in one database.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram of a system including multiple ERP systems and one WMS.

FIG. 2 is a flowchart showing a warehouse process in the system of FIG. 1.

FIG. 3 is a schematic diagram of how filter criteria are used in the process shown in FIG. 2.

Like reference symbols in the various drawings indicate like elements.

### DETAILED DESCRIPTION

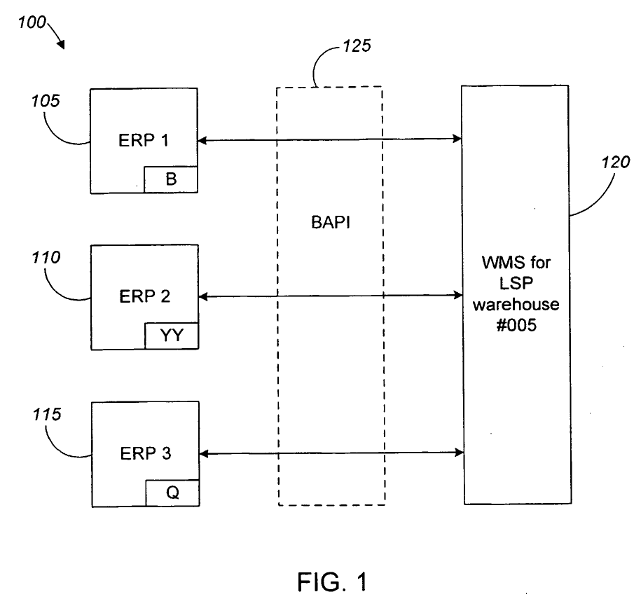

As shown in FIG. 1, a system (100) in accordance with the invention includes multiple Enterprise Resource Planning systems (105, 110, 115) and a single Warehouse Management System (120). Each ERP (105, 110, 115) is typically associated with a company or warehouse client and contains information related to the operations of the company, such as financing, controlling, purchasing, invoicing, import and export control, credit limit checks, available to promise, and so on. Each ERP (105, 110, 115) is identified by a logical system identifier. For example, as shown in FIG. 1, the logical system identifier for ERP 1 (105) is B, the logical system identifier for ERP 2 (110) is YY, and the logical system identifier for ERP 3 (115) is Q.

The WMS (120) is associated with a warehouse having a unique warehouse number and represents processes related to the stock keeping in the warehouse. Such stock keeping processes include, for example, keeping track of incoming and outgoing goods, keeping track of existing number of items in storage, at what locations in the warehouse specific items can be found, and so on. The WMS (120) is typically implemented as software running on a stand-alone computer or server, and obtains instructions from the different ERP systems (105, 110, 115) to which it is connected. In one implementation of the invention, the data in the ERP systems (105, 110, 115) and the WMSs (120) are represented as SAP business objects. The business objects represent central business objects in the real world, such as a purchase order, a contract, a customer, risks, telephone calls and so on. The communication between the ERP systems (105, 110, 115) and the WMS (120) take place by invoking methods known as BAPIs (Business Application Programming Interfaces) (125), which allow external applications to access and manipulate the business objects, for example, through the Internet, DCOM (Distributed Component Object Model) or CORBA (Common Object Request Broker Architecture) It should be noted that although only one WMS (120) is shown in FIG. 1, there are typically several WMSs in a system in accordance with the invention, each WMS having a unique identifying number.

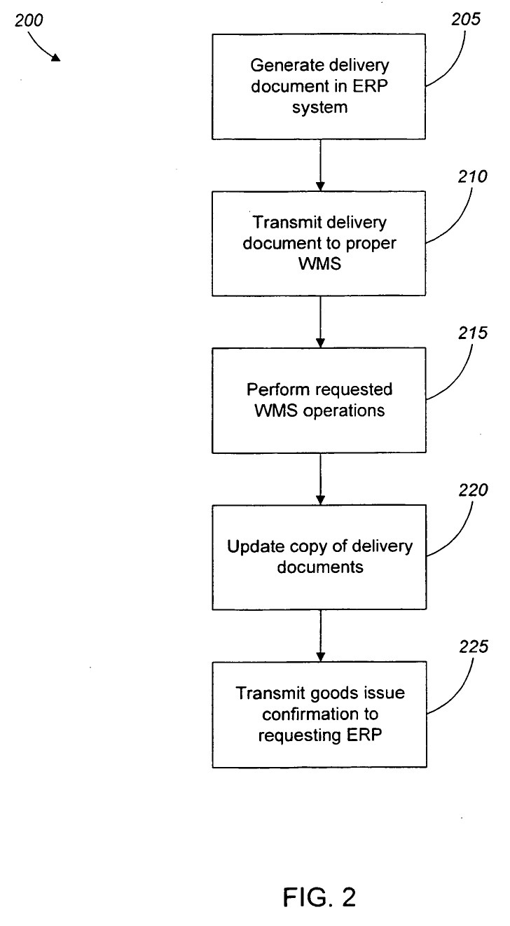

An exemplary process (200) for carrying out a warehouse operation in the system (100) shown in FIG. 1 will now be described with reference to the flowchart in FIG. 2. A request for a warehouse operation is generated in the ERP 2 system (110) (step 205). The request is represented by a delivery document, which includes the logical system identification YY of the ERP 2 system (110) as well as identifying the number of the warehouse (in this case #005) where the request should be carried out.

The delivery document can be used in processes for receiving, sending, or transferring goods. The delivery can be an inbound or outbound delivery. The delivery document including an inbound and outbound delivery, respectively, is typically made up of a document header and a number of document items. The general data relevant for the delivery is stored in the delivery document header. This data is valid for the entire document. The general data can include one or more of: shipping point, data about delivery scheduling and transportation scheduling (for example, the goods issue date or the date of delivery to the ship-to party), weights and volumes of the entire outbound delivery, sold-to party and the ship-to party numbers and the route. In the items section of the delivery document, data that applies to a particular item can be found. The data pertaining to the particular item can include one or more of: material number, delivery quantity, plant and storage location specifications, picking date, weights and volumes of the individual items, and tolerances for under delivery or over delivery. For the purpose of the present discussion, it can be assumed that the request contains a request to ship ten boxes of an item A to a specific customer.

After generation of the delivery document, the delivery document is transmitted over the BAPI (Business Application Programming Interface) (125) to the WMS (120) for the warehouse of the LSP that manages the storage and packing of item A for the requesting company (step 210). The warehouse number is used as a filter object in an ALE (Application Link Enabling) distribution model to determine to which WMS the delivery document should be sent.

When the delivery document arrives in the WMS (120) a copy is made and the request to ship the ten boxes of item A is carried out (step 215). After processing the request, the copy of the delivery document is updated with the results of the shipping operations performed in the warehouse (step 220). This copy is also referred to as a goods issue posting. Finally, a goods issue confirmation is transmitted back to ERP 2 (110), using the logical system identification YY obtained from the delivery document as an identifier (step 225).

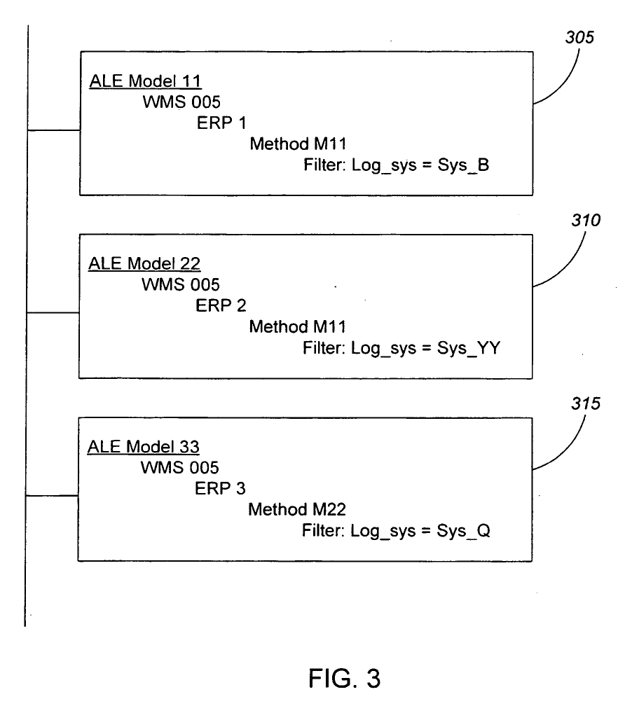

FIG. 3 shows in greater detail how the determination of the right ERP-system is performed after picking/putaway and packing in the WMS (120). Just like above, when the proper WMS (120) was determined, an ALE (Application Link Enabling) distribution model is used to determine to which ERP (105, 110, 115) the confirmation should be sent. If the goods issue confirmation in the ALE system is represented as a “Method 11,” the process first identifies all ALE objects that can perform the requested “Method M11.” As can be seen in FIG. 3, both object 305 and object 310 can perform “Method M 11,” that is, both ERP 1 (105) and ERP 2 (110) are candidates for receiving the goods issue confirmation. Object 315, however, can only perform a “Method M22,” and is consequently not a candidate for receiving the goods issue confirmation.

In order to distinguish between objects 305 and 310, the process applies the second filter criterion, which is the logical system identifier obtained in the distribution document, in the present example “YY.” Object 305 only supports the ERP with identifier B, that is, ERP 1 (105), but object 310 supports the ERP with identifier “YY,” that is, ERP 2 (110). Consequently, the confirmation should be sent to ERP 2 (110).

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. Accordingly, other embodiments are within the scope of the following claims.

What is claimed is:

1. A decentralized warehouse management system for managing data related to contents and operations of a warehouse, the decentralized warehouse management system being operable to:
receive a request from one enterprise resource planning system from among two or more enterprise resource planning systems that are operable to exchange information with the decentralized warehouse management system, the request representing one or more operations to be performed on the contents of the warehouse;
identify the enterprise resource planning system from among two or more enterprise resource planning systems that are operable to exchange information with the decentralized warehouse management system; and
send a response to the request to the enterprise resource planning system from which the request was received.

2. The decentralized warehouse management system of claim 1, wherein the decentralized warehouse management system is operable to:
identify the enterprise resource planning systems including receiving a unique identifier from the enterprise resource planning system from which the request was received.

3. The decentralized warehouse management system of claim A, wherein the decentralized warehouse management system is operable to:
use the unique identifier and determine to which enterprise resource planning system the response should be sent.

4. The decentralized warehouse management system of claim 2, wherein the unique identifier is a logical system identifier.

5. The decentralized warehouse management system of claim 2, wherein the unique identifier is received as part of the request.

6. The decentralized warehouse management system of claim 1, wherein the decentralized warehouse management system is operable to receive requests from and send responses to an enterprise resource planning systems over a Business Application Programming Interface.

7. The decentralized warehouse management system of claim 1, wherein the decentralized warehouse management system manages data related to one or more of: goods movement operations, controlling operations, and inventory operations of the warehouse.

8. The decentralized warehouse management system of claim 1, wherein the request is a delivery document.

9. The decentralized warehouse management system of claim 1, wherein the response is an updated delivery document.

10. The decentralized warehouse management system of claim 1, wherein the decentralized warehouse management system is operable to identify an enterprise resource planning system using one or more of: an enterprise resource planning system identifier, a method included in the received request, a warehouse identification number, and a logical system identifier.

11. A warehouse management method, comprising:
receiving a request from one enterprise resource planning system from among two or more enterprise resource planning systems that are operable to exchange information with the decentralized warehouse management system, the request representing one or more operations to be performed on the contents of the warehouse;
identifying the enterprise resource planning system from among two or more enterprise resource planning systems that are operable to exchange information with the decentralized warehouse management system; and
sending a response to the request to the enterprise resource planning system from which the request was received.

12. The warehouse management method of claim 11, wherein identifying comprises:
receiving a unique identifier from the enterprise resource planning system sending the request.

13. The warehouse management method of claim 12, further comprising:
using the unique identifier including determining to which enterprise resource planning system the response should be sent.

14. The warehouse management method of claim 12, wherein receiving a unique identifier comprises:
receiving a logical system identifier.

15. The warehouse management method of claim 12, wherein receiving a unique identifier comprises:
receiving a unique identifier as part of the request.

16. The warehouse management method of claim 11, wherein receiving a request comprises receiving a request over a Business Application Programming Interface; and
wherein sending a response comprises sending a resonse over the Business Application Programming Interface.

17. The warehouse management method of claim 11, further comprising:
carrying out instructions specified in the received request, the instructions being related to one or more of: goods movement operations, controlling operations, and inventory operations of the warehouse.

18. The warehouse management method of claim 11, wherein receiving a request comprises receiving a delivery document.

19. The warehouse management method of claim 11, wherein sending a response comprises sending an updated delivery document.

20. The warehouse management method of claim 11, wherein identifying comprises:
identifying an enterprise resource planning system using one or more of: an enterprise resource planning system identifier, a method included in a received request, a warehouse identification number, and a logical system identifier.

21. A system for managing warehouse operations, comprising:
two or more enterprise resource planning systems; and
a decentralized warehouse management system for managing data related to contents and operations of a warehouse;
wherein the enterprice resource planning systems are operable to:
send a delivery document to the decentralized warehouse management system over a business application programming interface, the delivery document including a unique identifier for the enterprise resource planning system that sends the delivery document; and
wherein the decentralized warehouse management system is operable to:
receive the delivery document with the unique identifier;
carry out instructions included in the delivery document; and
send an updated version of the delivery document to the enterprise resource planning system from which the delivery document was received, based on the unique identifier included in the delivery document.
